(19) United States
(12) Patent Application Publication
(10) Pub. No.: US 2018/0023527 A1
(43) Pub. Date: Jan. 25, 2018

(54) SOLENOID-BASED FUEL INJECTOR

(71) Applicant: SENTEC LTD, Cambridge (GB)

(72) Inventors: Andrew Dames, Cambridge (GB); Hilary Meanwell, Saffron Walden (GB); Robert Davidson, Auckland (NZ); Christian Wehrenfennig, Cambridge (GB); James Evett, Winslow (GB)

(21) Appl. No.: 15/545,813

(22) PCT Filed: Jan. 20, 2016
(86) PCT No.: PCT/GB2016/050120

§ 371 Date: Jul. 24, 2017

(30) Foreign Application Priority Data
Jan. 23, 2015 (GB) 1501122.4
Jan. 26, 2015 (GB) 1501214.9
Jan. 12, 2016 (GB) 1600530.8

(51) Int. Cl. F02M 51/06

(52) U.S. Cl. CPC F02M 51/0653; F02M 51/0692; F02M 2200/9053

(57) ABSTRACT

A solenoid-based fuel injector is described. The fuel injector comprises a tubular body (48) comprising a magnetic material and an armature (16) disposed inside the tubular body. The tubular body has an integrally-formed, inwardly-projecting shelf (52) configured to provide a pole piece.

### FIELD OF THE INVENTION

The present invention relates to a solenoid-based fuel injector.

### BACKGROUND

Solenoid-based fuel injectors can offer similar performance to piezo-based fuel injectors, but at lower costs. Examples of solenoid-based fuel injectors are described in WO 2011/058344 A1, WO 2012/172351 A2 and WO 2015/071686 A1, the contents of which are incorporated herein by reference.

Ever-greater demands are being placed on the performance of the internal combustion engine and its fuel injection system. For example, fuel pressures in gasoline direct injection (GDI) are expected to reach 500 bar (50 MPa) or more.

### SUMMARY

According to a first aspect of the present invention there is provided a solenoid-based fuel injector. The fuel injector comprises a tubular body which comprises a magnetic material and an armature disposed inside the tubular body. The tubular body has an integrally-formed, inwardly-projecting shelf configured to provide a pole piece.

Thus, the fuel injector can be assembled more easily and/or reliably by sequentially placing the armature and a further pole piece into the tubular body.

The tubular body and inwardly-projecting shelf are preferably formed in a single piece.

The shelf projects by an annular width and has a length in a direction along which the tubular body extends. The length is preferably at least the annular width. The annular width may be at least 2 mm, at least 2.5 mm or at least 4 mm. The annular width may be no more than 6 mm, no more than 4 mm or no more than 3.5 mm.

The tubular body may be formed from a magnetic stainless steel or other suitably strong, suitable magnetic material. The magnetic stainless steel may be 17-7PH tempered or 17-4PH tempered grades of stainless steel. The magnetic stainless steel may be martensitic stainless steel. The stainless steel preferably has an endurance strength between 300 to 600 MPa or higher. The tubular body may have a wall thickness, t, of at least 0.2 mm, at least 0.5 mm or at least 1 mm.

The fuel injector preferably comprises first and second pole pieces. The first pole piece (or “upper pole piece”) is disposed relatively close to a fuel inlet end of the tubular body and the second pole piece (or “lower pole piece”) is disposed relatively far from the fuel inlet end of the tubular body. The inwardly-projecting shelf preferably provides the second pole piece.

A maximum gap between the armature and the inwardly-projecting shelf may be no more than 1 mm, no more than 0.5 mm, no more than 0.2 mm or no more than 0.1 mm.

The fuel injector may further comprise a spacer element which limits the movement of the armature towards the first pole piece. The first pole piece and spacer element may be integrally-formed. The first pole piece and spacer element may be formed in a single piece. The spacer element may comprise a ring-like projection.

The fuel injector may further comprise a nozzle. The nozzle may be integrally-formed with the tubular body. The tubular body and the nozzle may be formed in a single piece.

The tubular body may comprise a first longitudinal section, a second longitudinal section in which the armature is disposed and a third longitudinal section in which the inwardly-projecting shelf is disposed, wherein the second longitudinal section is interposed between the first and third longitudinal sections. The first, second and third longitudinal sections may have first, second and third wall thicknesses respectively and the second wall thickness is less than the first wall thickness.

The first, second and third longitudinal sections have first, second and third inner wall thicknesses respectively. Preferably, the second inner wall thickness is less than the third wall thickness.

The tubular body may comprise fourth, fifth, sixth, seventh and eighth longitudinal sections having fourth, fifth, sixth, seventh and eighth wall thicknesses respectively, wherein the fifth and seventh longitudinal sections are disposed adjacent to first and second gaps between the first pole piece and the armature and the armature and the second pole piece respectively, the sixth longitudinal section is interposed between the fifth and seventh longitudinal sections and the fifth, sixth and seventh longitudinal sections are interposed between the fourth and eighth longitudinal sections. The fifth and seventh wall thicknesses may be each less than the sixth wall thickness.

The fifth and seventh wall thicknesses are each preferably less than the fourth and eighth wall thicknesses. The fifth and seventh wall thicknesses are preferably the same. The fourth and eighth wall thicknesses, and optionally the sixth wall thickness, are preferably the same.

The fuel injector may comprise at least one permanent magnet disposed outside the tubular body.

The fuel injector may comprise a collar-like sub-assembly arranged around the tubular body, the sub-assembly comprising a cup-like housing, a coil and a stator. The coil and stator are longitudinally spaced and are disposed within the cup-like housing such that the coil and stator are interposed between an outer wall of the housing and the tubular body.

The sub assembly may further include at least one permanent magnet disposed within the cup-like housing.

The at least one permanent magnet may comprise at least two permanent magnets. The at least two permanent magnets may be arc-shaped arranged to form a continuous ring. The magnetisation(s) of the, of each, permanent magnet may be orientated inwardly or outwardly. The magnetisation(s) of the, of each, permanent magnet may be orientated radially.

The permanent magnet(s) may be configured to saturate at least one section of the tubular body adjacent to the pole gaps and the armature.

The fuel injector may further comprise a needle or rod arranged to couple the armature to a valve closing member. The armature and the needle or rod may be integrally formed. The armature and the needle or rod may be formed in a single piece.

If the armature and the needle or rod are fixed together and the armature is configured so that it cannot move beyond half way between first and second pole pieces (for example, additional a spacer element can be used), then no springs (even a calibration spring) is needed. This is because the valve closes when the coil is not energised and the permanent magnet produces enough force to seat the sealing element.

The needle or rod may be compliant. For example, the needle or rod may be sufficiently thin so as to be stretchable during operation.

The fuel injector may further comprise a spring configured to help open the injector. Thus, a solenoid which provides a larger magnetic closing force than required for sealing may be used.

The needle or rod may be moveable between a first position in which the injector is closed and a second position in which the injector is open and wherein the needle or rod may be axially moveable with respect to the armature and includes a head arranged to engage the armature such that when the armature moves away from the pole piece, the armature strikes the head so as to encourage the needle or rod to move towards the second position.

The fuel injector may further comprise a spring arranged to bias the armature towards the head of the needle or rod.

The armature has first and second ends. The needle or rod includes a collar. The armature is disposed between the head and the collar and the spring is disposed between the armature and the collar.

The fuel injector may further comprise an armature bearing disposed inside the tubular body. This can help reduce a gap between the armature and the tubular body which can permit a more efficient flux path for the actuator. The fuel injector may further comprise a needle or rod bearing disposed inside the tubular body.

The fuel injector may further comprise a main spring arranged to apply a mechanical force to a needle or rod which changes with movement of the needle at a rate of at least 0.02 Nμm⁻¹, at least 0.1 Nμm⁻¹, at least 0.2 Nμm⁻¹, at least 0.5 Nμm⁻¹ or at least 0.8 Nμm⁻¹. The main spring has a neutral position in which the main spring does not apply a force to the needle or rod and which is deformable, away from the neutral position, along a longitudinal axis in first and second opposite directions so as to apply respective forces to the needle or rod.

The main spring may comprise a disc spring or more than one disc springs. The disc spring may comprise a sheet of material deformed by deep drawing or pressing. The disc spring may be arranged to provide a bearing for a needle or rod. The disc spring may include holes for allowing fuel to flow through the disc spring.

The main spring (which may be a disc spring) may be attached to the tubular body or to a pole piece, for example, by weld(s). The main spring (which may be a disc spring) may be attached to the needle or rod, for example, by weld(s).

If the main spring comprises a disc spring having inner and outer peripheries, the spring may be attached to the tubular body or to the pole piece by its outer periphery and/or the spring may be attached to needle or rod by its inner periphery.

The main spring may have linear stiffness.

The fuel injector may further comprise a calibration spring arranged to provide an offset bias. The calibration spring preferably has a stiffness of between 0.003 Nμm⁻¹ to 0.02 Nμm⁻¹. The calibration spring may be a helical spring.

The fuel injector may be for gasoline direct injection. The fuel injector may be a diesel injector. The fuel injector may be a gaseous injector.

The fuel injector may be an inward-opening injector or an outward-opening injector.

According to a second aspect of the present invention is provided a method of assembling a solenoid-based fuel injector. The method may comprise providing a tubular body comprising a magnetic material having an integrally-formed, inwardly-projecting shelf for providing a pole piece and disposing an armature inside the tubular body. Disposing the armature inside the tubular body may comprise placing the armature in the tubular body, for example, by dropping the armature into the tubular body.

The pole piece may be a first pole piece and the method may further comprise disposing a second pole piece in the tubular body such that the armature is interposed between the first and second pole pieces. Disposing the second pole piece in the tubular body may comprise placing the second pole piece in the tubular body. The second pole piece may be secured, for example, by welding and/or by push-fitting.

The method may further comprise arranging a collar-like sub-assembly around the tubular body. The sub-assembly may comprise a cup-like housing, a coil and a stator. The coil and stator are longitudinally spaced and are disposed within the cup-like housing such that the coil and stator are interposed between an outer wall of the housing and the tubular body.

### BRIEF DESCRIPTION OF THE DRAWINGS

Certain embodiments of the present invention will now be described, by way of example, with reference to the accompanying drawings, in which:

FIG. 1 is a cross-sectional view of a first fuel injection valve;

FIG. 2 is a cross-sectional view of a second fuel injection valve;

FIG. 3 is a cross-sectional view of a third fuel injection valve;

FIG. 4 is a cross-sectional view of a fourth fuel injection valve;

FIG. 5 is a cross-sectional view of a fifth fuel injection valve;

FIG. 6 is a cross-sectional view of a sixth fuel injection valve;

FIG. 7 is a cross-sectional view of a seventh fuel injection valve;

FIG. 8 is a perspective view of a spring which may apply a force on either side of a neutral position;

FIG. 9 is cross-sectional view of the spring shown in FIG. 8 taken along the line A-A′;

FIG. 10 is a cross-sectional view of an eighth fuel injection valve;

FIG. 11 is a cross-sectional view of a ninth fuel injection valve;

FIG. 12 is a cross-sectional view of a tenth fuel injection valve;

FIG. 13 is a cross-sectional view of an eleventh fuel injection valve;

FIG. 14 is a cross-sectional view of a twelfth fuel injection valve shown in FIG. 15;

FIG. 15 is a side view of a twelfth fuel injection valve;

FIG. 16 is a cross-sectional view of a thirteenth fuel injection valve;

FIG. 17 is a plot of displacement against force for a stiff spring;

FIG. 18 is a plot of stress against displacement for a stiff spring;

FIG. 19 illustrates forces exerted on a needle or rod of an outward-opening injector;

FIG. 20 illustrates forces exerted on a needle or rod of an inward-opening injector;

FIG. 21 is a cross-sectional view of a fourteenth fuel injection valve; and

FIG. 22 is a cross-sectional view of a fifteenth fuel injection valve.

### DETAILED DESCRIPTION OF CERTAIN EMBODIMENTS

In the following, like parts are denoted by like reference numerals.

### First Fuel Injection Valve 1₁

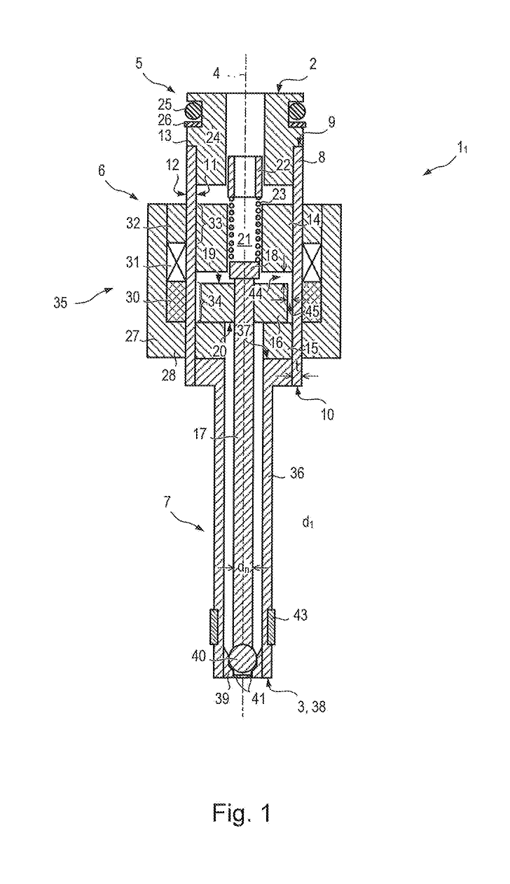

Referring to FIG. 1, a first solenoid-based fuel injection valve 1₁ (herein also referred to simply as a “fuel injector” or “injector”) is shown.

The fuel injector extends between first and second ends 2, 3 along a longitudinal axis 4. The fuel injector is substantially cylindrically symmetrical about the longitudinal axis 4.

The injector takes the form of a multipart assembly which includes a first section 5 (herein referred to as a “main section”), an outer sub-assembly 6 which is disposed around the first section 5 and a second section 7 (which is also referred to as the “nozzle section”) which is attached to the first section 5. Fuel (not shown) is introduced into the injector via a high-pressure tube (not shown) into the first end 2 of the injector and is controllably discharged from the second end 3 of the injector.

The injector can be used to inject fuel (not shown) into a chamber of an automotive internal combustion engine (not shown) and can have suitable dimensions, e.g. an outer diameter of about 21 mm.

The main section 5 includes a tubular body 8 (herein also referred to as a “pressure tube”) having first and second ends 9, 10 and inner and outer wall surfaces 11, 12, an annular fuel inlet connector 13 attached to the first end 9 of the tubular body 8, first and second annular pole pieces 14, 15 disposed inside, and spaced apart along, the tubular body 8, an armature 16 interposed between the first and second pole pieces 14, 15.

A needle 17 (which may also be referred to as “pintle” or “shaft”) has a head 18 (or “stud”) which passes through the armature 16. The needle 17 extends through a first armature face 19 (herein also referred to as the “upper face”) which faces the first end 2 of the injector, through the armature 16, through a second opposite armature face 20 (herein also referred to as the “lower face”) towards the second end 3 of the injector. The needle 17 extends beyond the second end 10 of the tubular body 8 and into the nozzle section 7. The needle 17 is free to slide axially through the armature 16. The needle 17 has a diameter, dₙ, of about 2 mm and a length, lₙ, of about 30 mm. The needle 17 may be shorter or longer, for example, lie in a range between 20 and 70 mm.

The tubular body 8 is formed from a magnetic stainless steel or other suitably strong, suitable magnetic material. The magnetic stainless steel may be 17-7PH tempered or 17-4PH tempered grades stainless steel. The magnetic stainless steel may be martensitic stainless steel. The stainless steel preferably has an endurance strength between 300 to 600 MPa or higher. The tubular body 8 has a wall thickness, t, of about 1 mm, but may be a low as 0.2 mm is some instances, depending on the fuel pressures.

The first and second pole pieces 14, 15 (herein also referred to as the “upper pole piece” and “lower pole piece” respectively) may be formed from a magnetic stainless steel or other suitable magnetic material. The magnetic stainless steel may be a ferritic or martensitic steel, or a cobalt steel, such as Vacoflux 9CR®.

The pressure tube 8, annular fuel inlet connector 13 and pole pieces 14, 15 define a central passage 21 through which fuel (not shown) can flow. The first section 5 also includes an annular calibration pin 22 which is disposed in the central passage 21 between the first end 2 of the injector and the armature 16 and which is moveable along the axis 4 and a calibration spring 23 which is interposed between the stud 18 and the annular calibration pin 22. The calibration spring 23 takes the form of a helical spring which is usually (although not necessarily) compressed between the stud 18 and the calibration pin 23. The calibration spring 23 can apply a force, for example 25 N, to seal the valve when no fuel pressure is applied.

The fuel inlet connector 13 has an annular recess 24 close to the first end 2 of the injector which houses an O-ring 25 and an annular back-up ring 26 which has a rectangular cross section. Alternative fuel inlet connections may be used, for example a pipe thread or a compression fitting.

The outer sub-assembly 6 includes a generally tubular housing 27 having at least one inwardly-projecting portion 28 which is aligned with the second pole piece 15 and which is generally cup shaped. An annular space is formed between the tubular body 8 and the tubular housing 27 in which are disposed an annular permanent magnet arrangement 3o having an inwardly (e.g. radially) orientated magnetization (not shown), a coil 31 and a stator 32. The stator 32 may comprise the same material as the pole pieces 14, 15. The coil 31 may be wound on to a bobbin (not shown).

The outer sub-assembly tubular housing 27 may be formed from a magnetic stainless steel or other suitable magnetic material and has a wall thickness lying in a range between 1 and 3 mm.

The permanent magnet arrangement 30 may comprise two or more magnets which are arc-shaped and which are arranged to form a continuous ring. Alternatively, the permanent magnet arrangement 30 may comprise two or more permanent magnets which are, for example which are bar-shaped, and which are angularly spaced around the tubular body 8. Alternatively, the permanent magnet arrangement may be a single-piece ring magnet. The magnets may comprise a rare-earth magnetic alloy such as, for example, samarium-cobalt (SmCo) or neodymium-iron-boron (NdFeB).

The pole pieces 14, 15, tubular housing 27, stator 32 and first and second sections 33, 34, and a third section radially abutting the pole piece 15 of the tubular body 8 provide a magnetic circuits for flux. The pole pieces 14, 15, armature 16, tubular housing 27, permanent magnets 30, coil 31 and stator 32 and the first and second tubular body sections 33, 34, and the third section form a solenoid actuator 35.

When the coil 31 is not energised, the armature 16 is latched in a first position, abutting the second pole piece 15 by the flux from the permanent magnet. The coil 31 is energised by passing a current in a direction which creates a flux which when combined with the flux from the permanent magnet causes the armature 16 to move towards the first pole piece 14. The direction of the current can be reversed which causes a force which acts in the opposite direction.

The nozzle section 7 comprises an elongate, tubular nozzle 36 having proximal and distal ends 37, 38. The proximal end 37 of the nozzle 36 is attached (for example, welded, brazed or fused) to the main section 5 of the injector. The nozzle 36 has an outwardly-projecting section at its proximal end 37 which is attached to the inner wall surface 11 of the pressure tube 8. The distal end 38 houses a valve seat 39 for a sealing element 40, in the form of a ball, which attached, for example by a weld, at a distal end of the needle 17. The valve seat 39 includes orifices 41 such that, when the sealing element 40 is unseated, i.e. withdrawn inwardly into the injector 1, fuel is forced under pressure through the orifices 41. The nozzle section 7 includes an annular recess 42 which houses a combustion seal 43.

A pole gap 44 between the armature 16 and the upper pole piece 14 is shown exaggerated in FIG. 1. The maximum pole gap corresponds to the maximum stroke of the injector, which may lie in the range between 25 and 800 μm. In some types of injector, for example in a gasoline direct injection (GDI) injector, the maximum stroke may lie in the range between 20 and 120 μm.

An annular gap 45 between the outer diameter of the armature 16 and the inner diameter of the pressure tube 8 (i.e. inner surface 11) is also shown exaggerated in FIG. 1. Typically, in injectors in which the interface between the armature 16 and the pressure tube 8 provides a bearing, the size of the gap 45 tends to be minimised, for example, less than 0.075 mm. However, if another part of the injector provides an alternative bearing, then the size of the gap 45 can be increased.

Suitable holes, grooves, flats on a shaft, annular clearance and other flow path features can be provided in the fuel injector to help ensure that the pressure seen at the inlet to the orifices 41 is substantially the same as the fuel pressure supplied to the inlet of the injector when the sealing element 40 has been sufficiently lifted.

### Second Fuel Injection Valve 1₂

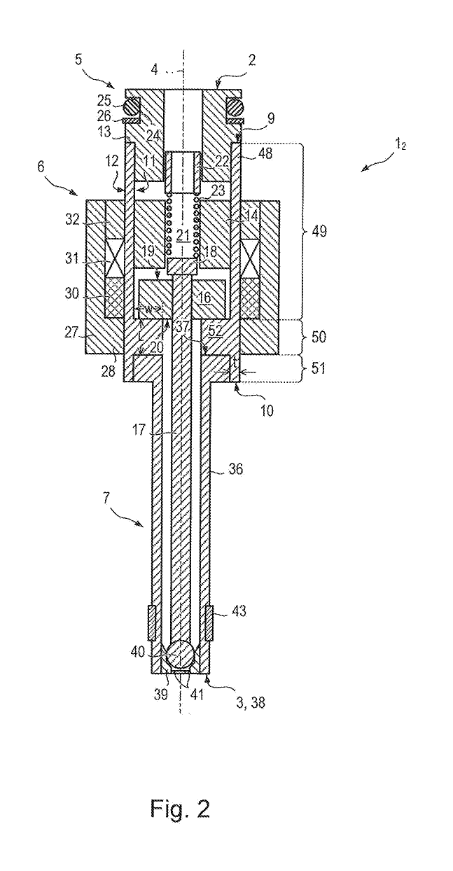

Referring to FIG. 2, a second solenoid-based fuel injector 1₂ is shown.

Referring also to FIG. 1, the second fuel injector 1₂ is the same as the first fuel injector 1₁ except that instead of separate tubular body 8 and second pole piece 15, the second fuel injector 1₂ comprises a tubular body 48 having first, second and third sections 49, 50, 51 (which may also be referred to as “wall sections” or simply “walls”) between the first and second ends 2, 3 and an integrally-formed pole piece 52.

In the first and third sections 49, 51, the tubular body 48 has the same inner diameter and outer diameter as the tubular body 8 of the first injector 1₁. The inner diameter of the third section may be modified to form a convenient interface with the tubular nozzle 36. In the second section 50, however, the tubular body 48 has a smaller inner diameter thereby forming an inwardly-projecting shelf 52. The inwardly-projecting shelf 52 provides the second pole piece. The dimensions of the shelf 52 are the same or similar to the dimensions of the second pole piece 15. The pole piece 52 has an annular width, w, and a length, L, which is at least the same as the width. In this case, the shelf 52 projects inwardly by, i.e. has an annular width, w, of about 2 mm, about 3 mm or about 4 mm.

The tubular body 48 and the second pole piece 52 are single-piece. For example, the tubular body 48 and the second pole piece 52 may be machined from a single piece of suitable high tensile strength magnetic material, formed by metal-injection moulding using the same material or formed by another suitable method. Thus, the tubular body 48 and the second pole piece 52 comprise the same material.

This arrangement can facilitate assembly of the fuel injector.

### Third Fuel Injection Valve 1₃

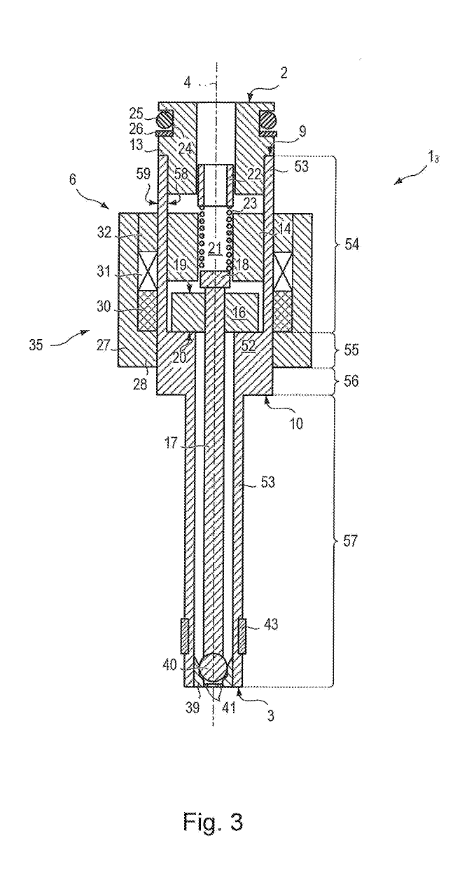

Referring to FIG. 3, a third solenoid-based fuel injector 1₃ is shown.

Referring also to FIG. 2, the third fuel injector 1₃ is the same as the second fuel injector 1₂ except that instead of a separate tubular body 48 and tubular nozzle 36, the third fuel injector 1₃ has a unitary tubular body and nozzle 53.

The unitary body and nozzle 53 comprises first, second, third and fourth and third sections 54, 55, 56, 57 (which may also be referred to as “wall sections” or simply “walls”) between the first and second ends 2, 3 and has inner and outer wall surfaces 58, 59.

The unitary tubular body and nozzle 53 is single piece. For example, the tubular body and nozzle 51 may be machined from a single piece of suitable high tensile strength magnetic material, formed by metal-injection moulding using the same material or formed by another suitable method. Thus, the tubular body and nozzle 51 comprise the same material.

### Fourth Fuel Injection Valve 1₄

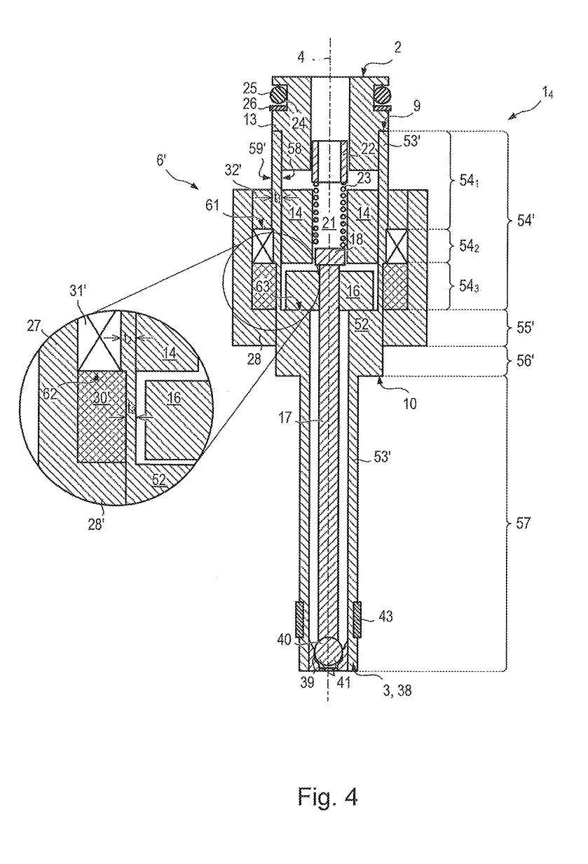

Referring to FIG. 4, a fourth solenoid-based fuel injector 1₄ is shown.

Referring also to FIG. 3, the fourth fuel injector 1₄ is the same as the third fuel injector 1₃ except that a modified unitary tubular body and nozzle 53′ is used which has modified first, second and third wall sections 54′, 55′, 56′ and a modified outer sub-assembly 6′.

In the first, second and third wall sections 54′, 55′, 56′, the modified unitary tubular body and nozzle 53′ has a stepped outer surface 59′. The outer sub-assembly 6′ has an inwardly-projecting portion 28′, permanent magnet 30′, coil 31′ and stator 32′ which are adapted to follow the stepped contour of the of the outer wall surface 59′.

The first wall section 54′ has first, second and third stepped sections 54₁, 54₂, 54₃ (herein also referred to “steps”). The first, second and third and sections 54₁, 54₂, 54₃ have first, second and third wall thickness, t₁, t₂, t₃ respectively, where t₁>t₂>t₃. The first thickness t₁ is about 1 mm and the third thickness, t₃, is about 0.6 mm, although it may be as thin as 0.2 mm. These thicknesses are examples and can be changed to provide the strength required to contain the fuel pressure.

The step 54₁ extends from the end 9 of the tubular body portion to a point approximately level with a first end 61 of the coil 31′ or, if one is used, its bobbin (not shown). The second step 54₂ extends to a point approximately level with the second end 62 of the coil 31′ or, if one is used, its bobbin (not shown). The third step 54₃ continues to a point approximately level with the face 63 of the second pole piece 50, i.e. the shelf.

In the second and third wall sections 55′, 56′ (i.e. those sections which provide the pole piece and the transition between the pressure tube and nozzle), the outer diameter of the tubular body section 53′ is the same as the third stepped section 54₃. In the third wall section 56′, variation in diameter and shape may be made to suit the mounting of the injector to the engine.

The stepped outer surface arrangement can facilitate assembly of the solenoid-based fuel injector 1₄ since the tubular body potion 53′ can be inserted into the outer sub-assembly 6′ and the two parts be longitudinally aligned. The two parts may be fixed together, for example, by welding.

A stepped outer surface arrangement can be used with a two-piece tubular body and nozzle, such as that shown in FIG. 2.

### Fifth Fuel Injection Valve 1₅

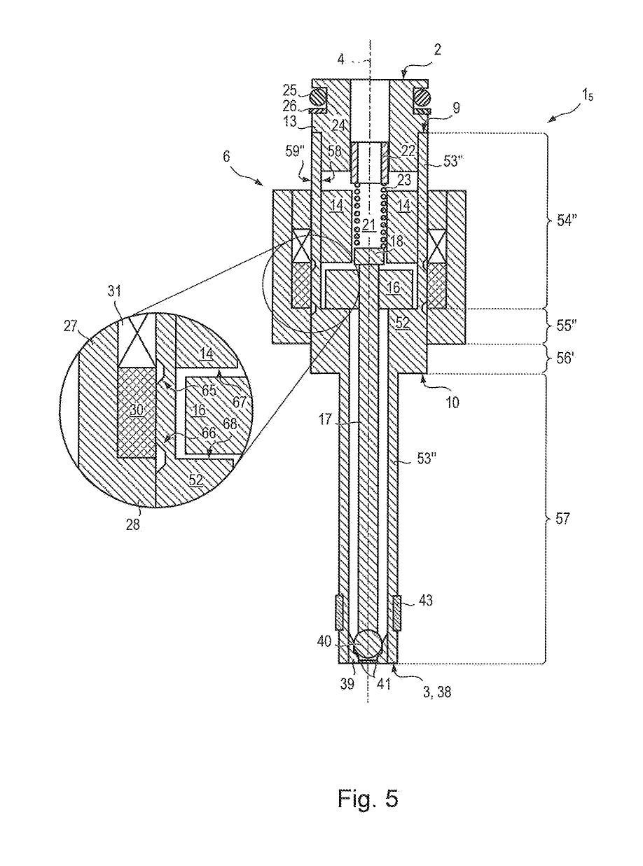

Referring to FIG. 5, a fourth solenoid-based fuel injector 1₅ is shown.

Referring also to FIG. 3, the fifth fuel injector 1₅ is the same as the third fuel injector 1₃ except that a modified unitary tubular body and nozzle 53″ is used which has modified first and second wall sections 54″, 55″.

The first and second walls 54″, 55″ include first and second annular recesses 65, 66 (or “thinned zones”). The annular recesses 65, 66 are aligned with the level of the faces 67, 68 of the first and second pole pieces 14, 52 respectively, i.e. so as to be level with the pole gaps.

This can be used to reduce flux shunting in the tubular body and can reduce eddy currents.

A recessed outer surface arrangement can be used with a two-piece tubular body and nozzle, such as that shown in FIG. 2.

### Sixth Fuel Injection Valve 1₆

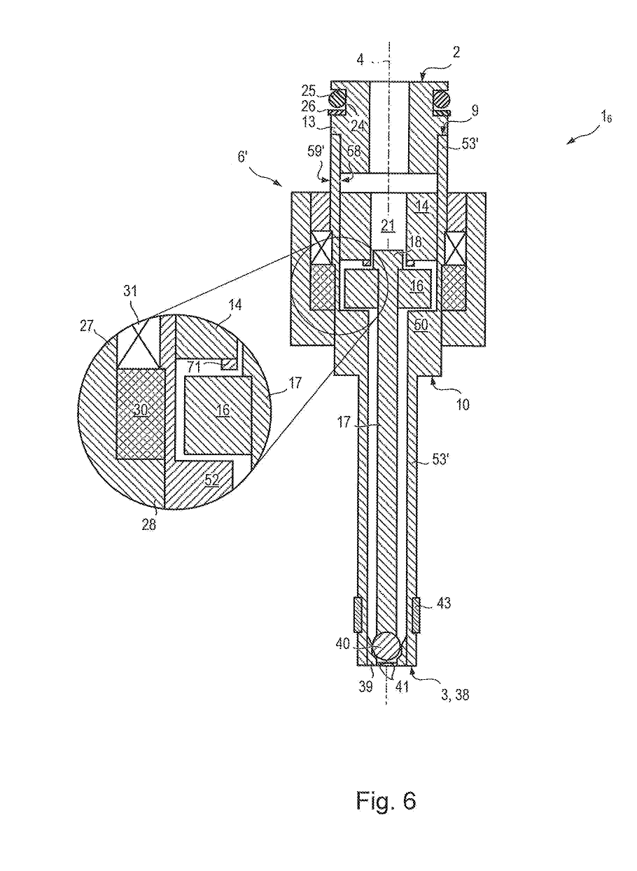

Referring to FIG. 6, a sixth solenoid-based fuel injector 1₆ is shown.

Referring also to FIG. 4, the sixth fuel injector 1₆ is the same as the fourth fuel injector 1₄ except that the needle 17 is attached (for example, welded) to the armature 16, that an annular spacer element 71 projects from the first pole piece 14 towards the armature 16 and that the calibration pin 22 and spring 23 are omitted.

The sixth fuel injector 16 is suited for applications in which the forces required the lift the sealing element are reduced for example a small sealing element 4o and or low fuel pressures, which does not exceed 200 bar (20 MPa).

### Seventh Fuel Injection Valve 1₇

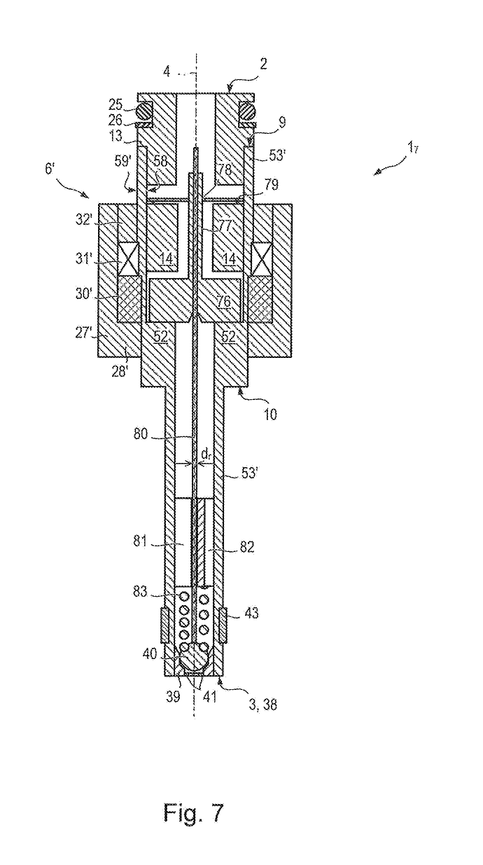

Referring to FIG. 7, a seventh solenoid-based fuel injector 1₇ is shown.

Referring also to FIG. 4, the seventh fuel injector 1₇ is the same as the fourth fuel injector 1₄ except that a different armature, needle and spring arrangement is used.

The seventh fuel injector 1₇ includes an armature 76 having an elongate tubular collar 77 which extends towards the upper end 2 of the injector. The collar 78 may be formed by welding or pressing a tube to the armature. An upper section 78 of the collar 77 is attached (for example, welded) or abutted against by a calibration spring (not shown) to a stiff spring 79 in the form of disc spring which is also attached to the inner wall of the unitary tubular body and nozzle 53′. Other forms of stiff spring may be used. The stiff spring 79 has a stiffness of in the range of 0.02 Nμm⁻¹ to 2 Nμm⁻¹. The stiff spring 79 may allow partial lift of the armature, i.e. permits the armature to be stably positioned and held at a position between the pole pieces 14, 52. A calibration pin and calibration spring (not shown) may also be used.

A rod needle 80 (or “pintle shaft”) runs through, and is attached to, the tubular collar 77. A point of attachment point may be close or at the distal end of the collar 77. The rod needle 80 has a diameter, dᵣ, of about 0.5 mm. The rod needle 80 also runs through a guide element 81 disposed in the nozzle portion. The guide element 81 includes longitudinally-orientated channels 82 for allowing fuel (not shown) to flow. The guide element 81 not only helps to avoid buckling, but also provides damping.

A further spring 83 may be disposed between the guide element 81 and the sealing element 40 and is used to help seal the valve when there is no fuel pressure. The further spring 83 takes the form of a helical spring and is less stiff than the stiff spring 79. The calibration spring (not shown) may be used instead of further spring 83.

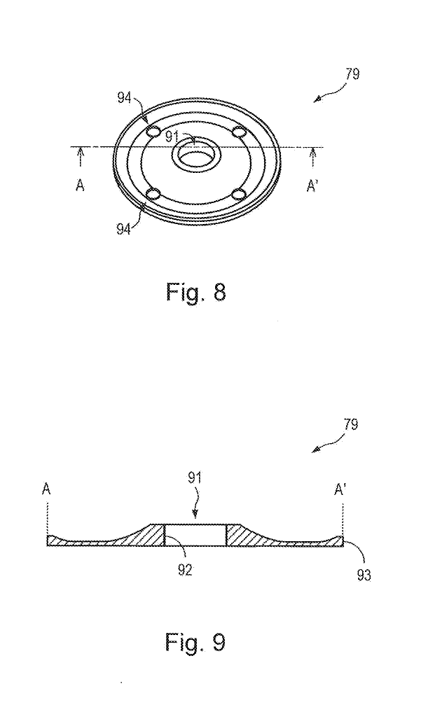

Referring also to FIGS. 8 and 9, the disc spring 79 comprises a generally flat disc having an inner aperture 91, defining an inner periphery 92, and an outer periphery 93. The disc spring 79 may include a plurality of holes 94 to allow the flow of fuel (not shown) through the disc spring 79. The disc spring 79 may also be formed from sheet material which is deformed using a low-cost process such as pressing or deep drawing.

Unlike the two-part armature and needle arrangement used, for example, in the second injector 1₂ (FIG. 2), the armature 76 and the rod needle 80 are fixedly attached to each other. Moreover, the rod needle 80 is thinner making it more compliant, although not so thin and not made of material that that its endurance strength is exceeded during operation. The rod needle 80 may comprise high-tensile, drawn stainless steel although other materials can be used. In this case, the steel has a Young's Modulus of 200 GPa, and the rod needle has a diameter of 0.5 mm and a length of 30 mm. The rod needle length may be between 20 and 70 mm. Typically, the armature mass is in the range of 1 to 4 grams, but may vary from this range.

This arrangement can allow higher valve-opening forces by stretching the shaft 80 and allowing the armature 76 to accelerate before the valve opens. Compared to arrangements with the armature 76 and the rod needle 80 fixedly attached to each other which do not involve such stretching and acceleration, up to twice the opening force can achieved using an injector driver (not shown) capable of driving only single-polarity waveforms and up to four times using a driver (not shown) capable of driving dual-polarity waveforms. The dual-polarity driver initially drives a current in a direction which causes a negative force to be developed by a flux-switch actuator (i.e. an actuator configured and operating in a manner described in WO 2011/058344 A1). The negative force compresses the needle. The dual-polarity driver then drives a current in the opposite direction which produces a positive force in a valve-opening direction. Moreover, the arrangement is simpler.

The arrangement takes advantage of the fact that rod needle 80 can stretch allowing the velocity of the armature 76 to build up. This kinetic energy is then transferred to stretching the needle along with any continuing magnetic drive force until the valve opens. Initially in the single-polarity drive case, the force attempting to open the valve is less than that applied to the armature, as most of the force goes to accelerating the armature. In high-pressure fuel applications, prior to the valve opening, the armature begins to decelerate and its loss of momentum increases the force applied to the sealing element 40. Before the armature reaches the upper stop the force in the needle opens the valve.

In an actuator capable of supplying uniform force over the armature travel, a force of up to twice the static actuator force may be realised, provided that the force can be applied rapidly, ideally less than half, less than a third or less than a quarter of the natural period of the spring system formed by the pintle/armature with the end of the pintle held fixed by the closed valve, which is held fixed by the fuel pressure. Typically, the force is applied rapidly in about 100 μs. If the actuator force at the armature closed rest position is lower than with the armature lifted, the enhanced force may be even greater, as the armature is lifted up into regions of higher applied magnetic force as the pintle is stretched.

Similarly, if a constant magnetic closing force (due the flux from the permanent magnet) exists with the armature in the valve closed position and an opening force promptly applied the force available to lift the sealing element is more than double the static force otherwise available, as it is the change in force on the needle that is doubled, allowing any closing force to be converted to an equivalent opening force (excluding any additional damping applied).

Damping may be provided for the valve-sealing element 40 when it is moving after it has lifted off the valve seat 40, as energy released from the stretched needle might otherwise cause rapid oscillations of the valve seal element height. This can be achieved by a closely-fitting sleeve 81 around the lower end of the pintle shaft 80, permitting effective viscous damping of the oscillations by the fuel. The closely-fitting sleeve 81 can also be used to ensure the needle does not buckle if a compressive force is applied.

### Eight Fuel Injection Valve 1₈

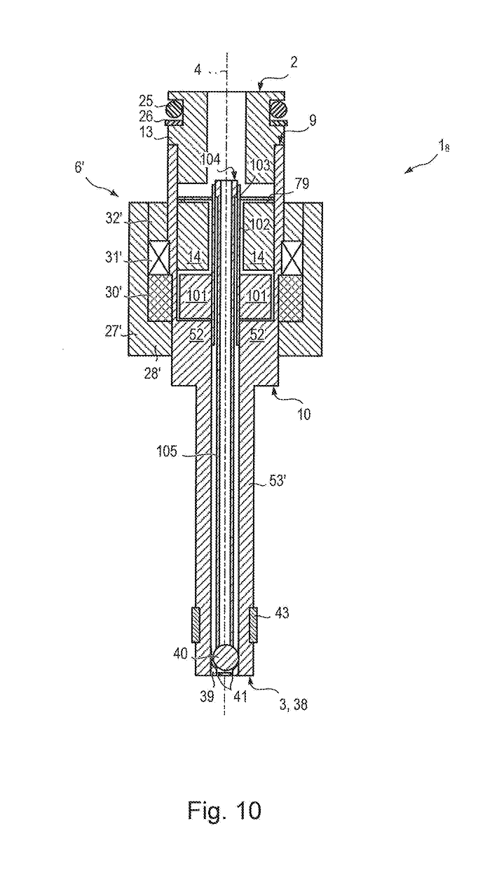

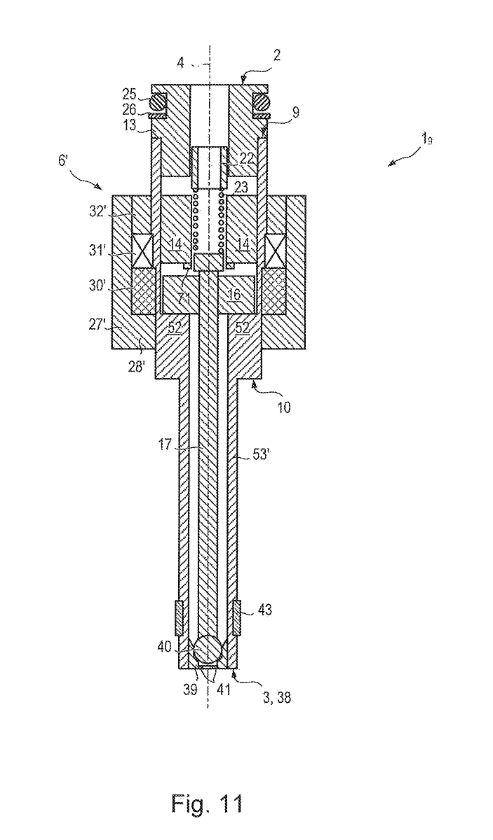

Referring to FIG. 10, an eighth solenoid-based fuel injector 1₈ is shown.

Referring also to FIG. 4, the eighth fuel injector 1₈ is the same as the fourth fuel injector 1₄ except that a different armature and needle arrangement is used and that additional springs can be omitted.

The eighth fuel injector 1₈ includes an armature 101 which is attached to an elongate tubular collar 102 which passes axially through the armature 101 and extends towards the upper end 2 of injector. An outer part of a distal end 103 of the collar 102 is attached (for example welded) to a stiff spring, for example in the form of a disc spring, which is also attached to inner wall of the unitary tubular body and nozzle 53′. An inner part of the distal end 103 of the collar 102 is attached (for example welded) to a first end 104 of a needle 105 which is proximate to the first end 2 of the injector. The other end 106 of the needle 105 is attached to the sealing member 40. The needle 105 may be hollow with a thin wall thickness.

The needle 105 is compliant and so eighth fuel injector 18 also can be used to achieve higher opening forces similar to the seventh fuel injector 1₇.

A calibration pin (not shown) and a calibration spring (not shown) may also be employed. The calibration spring may further be used to abut the stiff spring against the needle collar armature arrangement.

### Ninth Fuel Injection Valve 1₉

Referring to FIG. 9, a ninth solenoid-based fuel injector 1₉ is shown.

Referring also to FIG. 4, the ninth fuel injector 1₉ is the same as the fourth fuel injector 1₄ except that an annular spacer element 71 projects from the first pole piece 14 towards the armature 16. The element 71 acts as a fully open stop for the armature 14.

The actuator performance may be adjusted by including a non-magnetic spacer fixed to the upper pole piece or a radially narrow land machined into the upper pole piece 14.

The spacer or land provides a means of adjusting the differential forces produced by the actuator. The spacer or land enables the return force on the armature 71, when in the fully open position (when the coil current is zero), to be adjusted. The spacer or land may be used to adjust the magnetic stiffness of the actuator, which may enable reduced is stiff spring stiffness which enables lower hold open currents to be used in the coil 30.

### Tenth Fuel Injection Valve 1₁₀

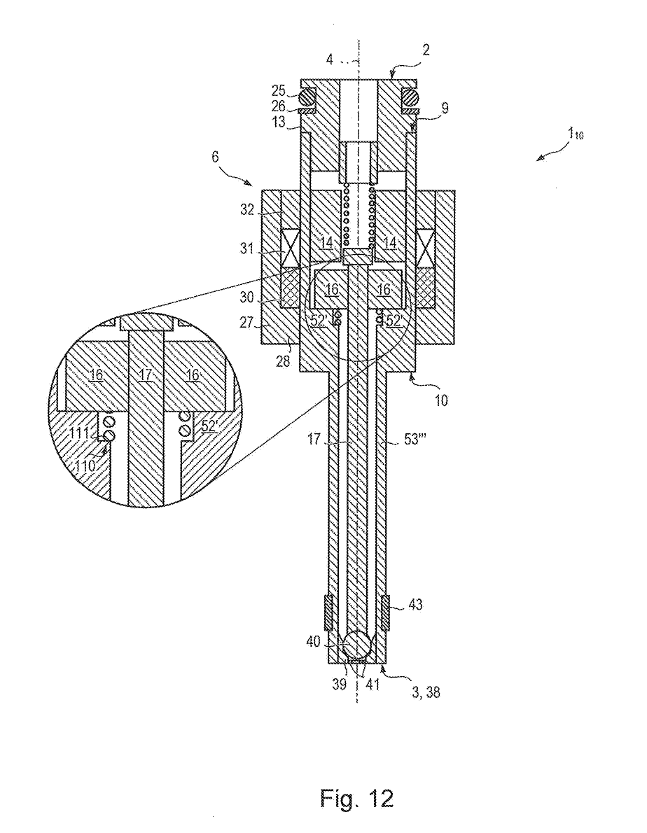

Referring to FIG. 12, a tenth solenoid-based fuel injector 1₁₀ is shown.

Referring also to FIG. 3, the tenth fuel injector 1₁₀ is the same as the third fuel injector 1₃ except that a modified pole piece 52′ is used which sacrifices an inner rim portion to provide a shelf 110 which allows a valve-opening spring 111 to be added between the shelf 110 and the armature 16 and so provide additional opening force on the armature 16. In this case, the stiff spring in takes the form of a helical spring. The stiff spring 111 may have a stiffness of 0.3 Nμm⁻¹ or less. The spring may exert a force of approximately 5 N.

### Eleventh Fuel Injection Valve 1₁₁

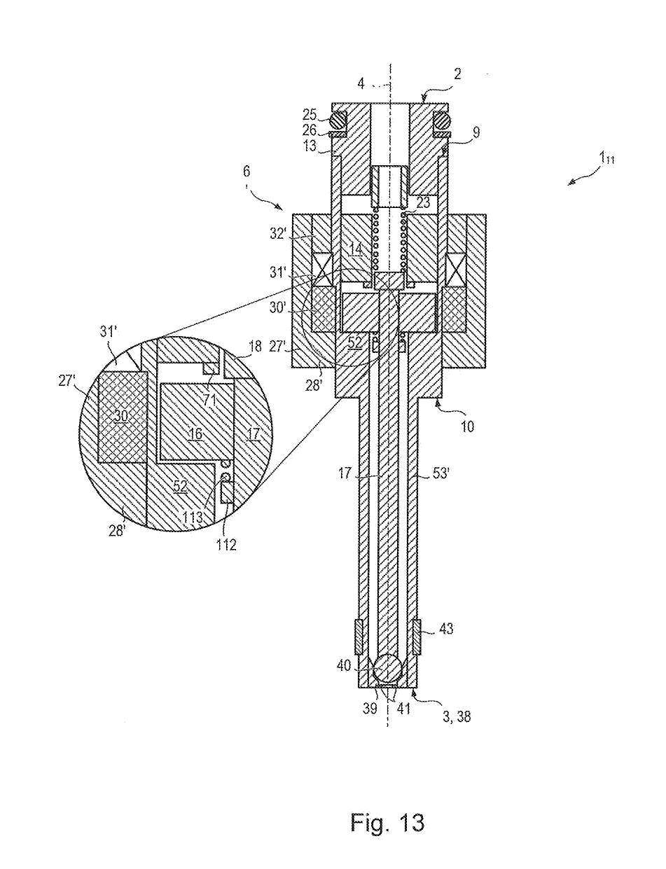

Referring to FIG. 13, an eleventh solenoid-based fuel injector 1₁₁ is shown.

Referring also to FIG. 4, the eleventh fuel injector 1₁₁ is the same as the fourth fuel injector 1₄ except that a short collar 112 is provided about the needle 17 close to the armature which a valve-sealing spring 113 to be added between the collar 112 and the armature 16.

The valve-sealing spring 113 can have a stiffness of about 0.3 Nμm⁻¹ or less and is used to apply a sealing force on the ball 40. As a result, a lighter calibration spring 23, i.e. one which applies less force or even zero force, can be used.

The collar 112 may have a spring (not shown) positioned below it, which abuts it and applies vertical force in an opening direction, if the magnetic sealing force generated by the permanent magnet is sufficiently large.

### Twelfth Fuel Injection Valve 1₁₂

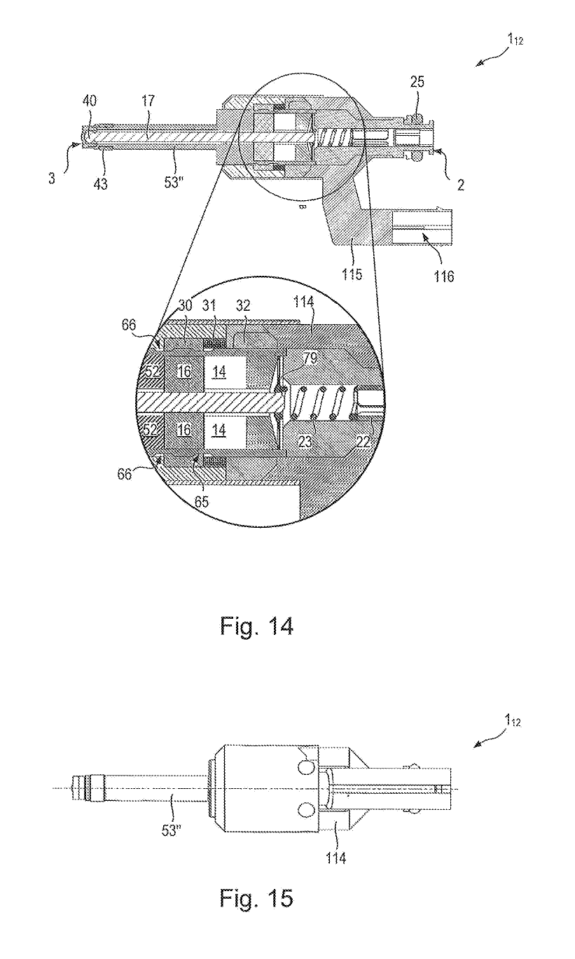

Referring to FIGS. 14 and 15, a twelfth solenoid-based fuel injector 1₁₂ is shown.

Referring also to FIG. 7, the twelfth fuel injector 1₁₂ is similar to the seventh fuel injector 1₇ differing mainly in that it does not have a stepped outer surface but, instead, annular recesses 65, 66. The twelfth fuel injector 1₁₂ includes unitary tubular body and nozzle 53″ having an integrally-formed lower pole piece 52. The needle 17 in this injector is not compliant as is the needle in FIG. 7.

FIGS. 14 and 15 also shows a plastic moulding 114 which is disposed around an upper portion of the unitary tubular body and nozzle 53″ having an arm 115 which accommodates an electrical connector 115, which houses two pins 116, to the coil 31.

### Thirteenth Fuel Injection Valve 1₁₃

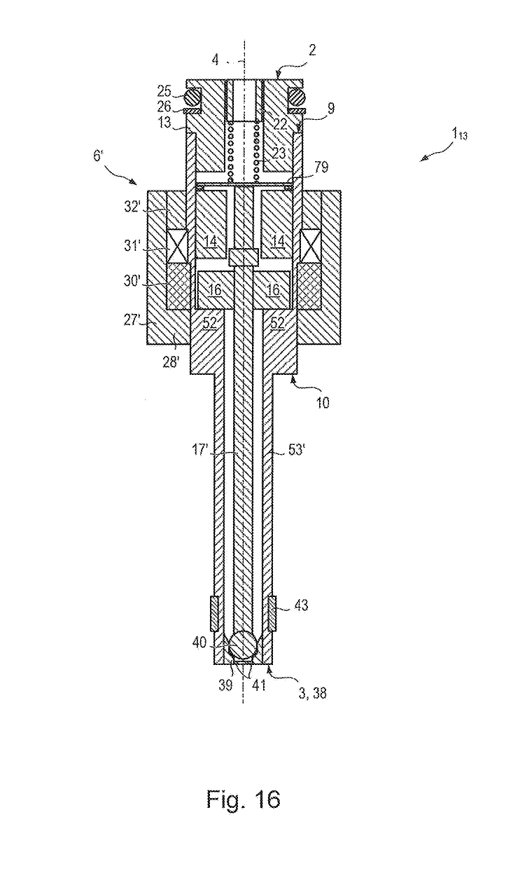

Referring to FIG. 16, a thirteenth solenoid-based fuel injector 1₁₃ is shown.

Referring also to FIG. 4, the thirteenth fuel injector 1₁₃ is similar to the fourth fuel injector 1₁₃, for example by virtue of a having a two-part armature and needle, except that it is provided with a stiff spring 79 and that the needle 17′ is longer. Furthermore, the calibration pin 22 and calibration spring 23 are disposed higher, i.e. closer to the fuel inlet end 2 of the injector.

The needle 17′ extends further towards the first end 2 of the injector where it is fixedly attached (or abutted by apply force by the calibration spring 23) to the stiff spring 79 in the form of a disc spring. The disc spring 79 is disposed in the same position as that found in the seventh fuel injector 1₇ (FIG. 7).

### Spring Performance

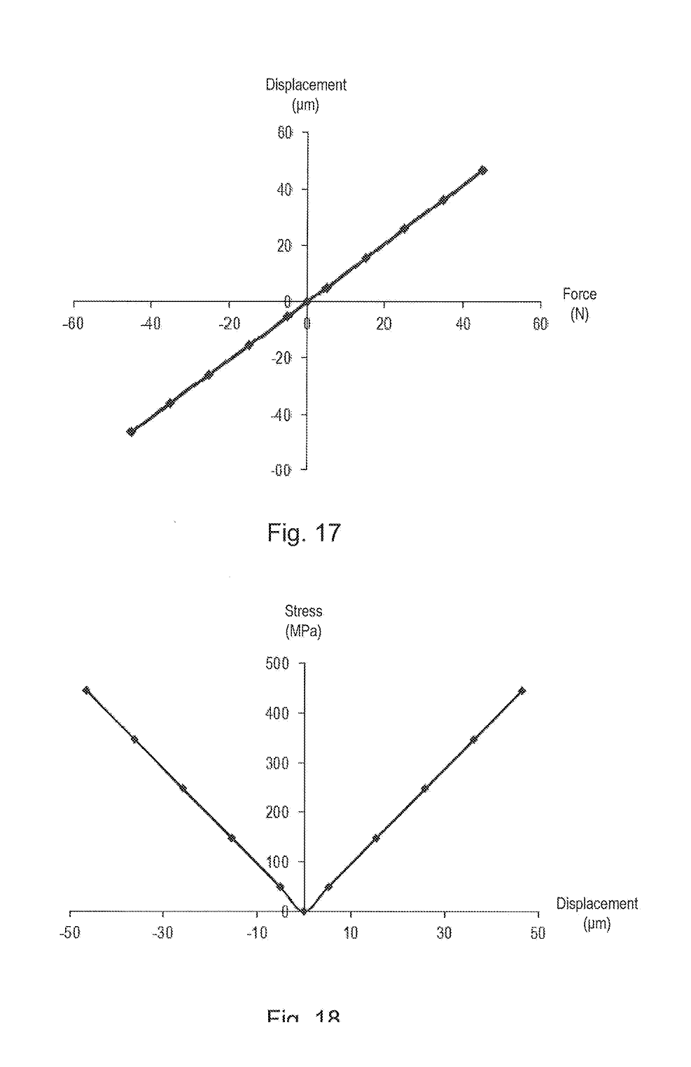

FIG. 17 is a graph of spring force against displacement from a neutral position for a stiff spring in the form of a disc spring, such as the disc spring 79 shown in FIGS. 8 and 9.

The graph shows the stiff spring flexing over a range of 90 μm. The graph shows the disc spring flexing between +45 μm and −45 μm relative to its neutral position which is defined as the position in which the stiff spring generates zero axial force and has zero stress. The gradient of the slope is the mechanical compliance of the spring, which in this case is about 1 μmN⁻¹, which is equivalent to a stiffness of 1 Nμm⁻¹.

A helical calibration spring may be used to bias the stiff spring to the −45 μm position when the injector is closed. Additional calibration spring force may be applied for producing a sealing (or a reaction) force between the ball and valve seat and to calibrate the injector. When the needle starts to lift the as the injector is actuated, the spring and is the calibration spring applies a force to the armature and needle.

Biasing a stiff spring using a calibration spring means that the stiff spring need only by urged against the needle and need not be welded to the needle. Furthermore, maximum stresses in the spring can minimised as it operates about is neutral point. The bias point can be chosen that it is half the stroke of the needle. It may be helpful, in some cases, to vary the proportion of bias so that is not symmetrical and so reduce the force needed to be applied by the calibration spring and, thus, reduce its mass.

Using a welded disc spring as a stiff spring can help to maintain angular alignment of components, for example if slots are used in the armature and pole pieces. However, the stiff spring can be a disc, a rod, a thin-walled tube or a three-dimensionally formed disc spring.

FIG. 18 is a graph of maximum tensile stress against displacement from a neutral position for a stiff spring whose stiffness is shown in FIG. 17.

The graph shows that maximum stress varies up to 450 MPa. The maximum tensile stressed portion of the spring moves from one side of the spring to the other as it goes through the neutral position. The spring should have a long fatigue life and biasing the spring (as hereinbefore described) can help to reduce the maximum tensile stress to which the spring is subjected for a given spring stiffness and needle lift. This means that a lighter, more compact spring can be used. This can be helpful to achieve small-sized injectors and to reduce the mass which needs to be accelerated in the injector when the valve is opened.

Suitable spring steels, such as 17-7PH with the heat treatment, are capable of providing the required endurance limits. The stiff spring may be shot peened or laser peened or vapour blasted to improve fatigue life.

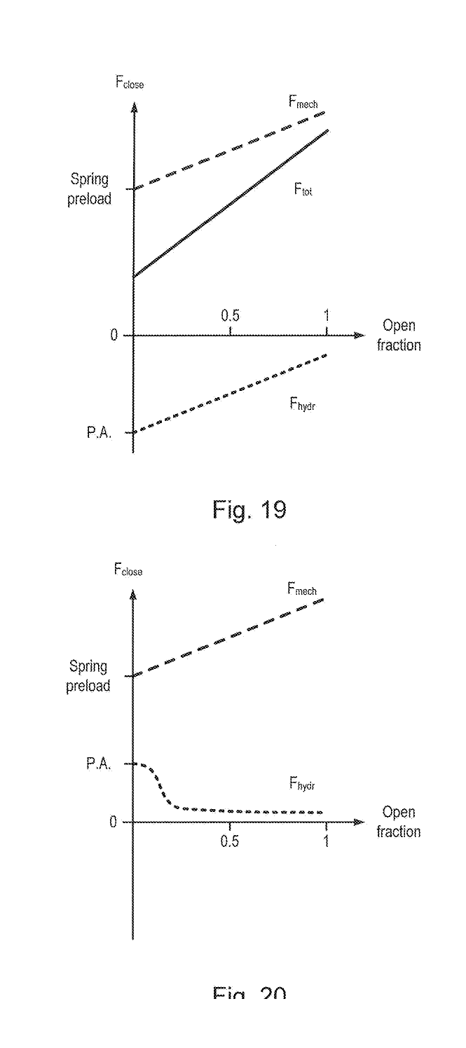

FIG. 19 shows the closing forces on the needle as the sealing element is opened for an outward opening injector. The mechanical force F_{mech} is shown as a dashed line. The slope of this line gives the mechanical stiffness. The mechanical stiffness is primarily set by the choice of stiff spring, which acts to exert an increasing force on the armature as the injector is opened. When the injector is fully closed, the value of this spring force (sometimes together with the magnetic latching force) is termed the “preload”.

Hydraulic forces acting on an armature or valve head also result in a contribution to the spring stiffness.

The hydraulic force is shown as a dotted line F_{hydr}. The hydraulic force from the pressurised fuel acts to push the injector open. When the injector is fully closed this has value −P.A, where P is the fuel line pressure (for example loo bar) and A is the total valve seat area on which the pressure is acting (for example, a seat area of diameter 4.5 mm). As the injector is opened, pressure drops across the opening area and the hydraulic force on the needle is reduced. Therefore, the hydraulic pressure contribution acts like a spring with a stiffness given by the slope of the line on a plot similar to FIG. 19. This stiffness can be of the order or 1.5 Nm⁻¹.

FIG. 20 shows the closing forces on the needle as the sealing element 40 is opened for an inward opening injector. An example of a hydraulic force F_{hydr} profile is shown as a dotted line, where this example is for a liquid fuel such as gasoline. The hydraulic force from the pressurised fuel is acting in the same direction as the mechanical spring: to push the injector closed. When the injector is fully closed this has value P.A, where P is the fuel line pressure (for example 150 bar) and A is the total valve seat area on which the pressure is acting (for example, a seat of diameter 1.7 mm). Typically the seat area for an inward opening injector may be smaller than an outward opening type, so this hydraulic force may be lower. As the needle is raised, the hydraulic force drops. For liquid fuels, most of the force reduction is expected to occur over a much smaller proportion of the valve lift. The hydraulic stiffness is again given by the slope of this line, but this time the slope is in the opposite direction to the mechanical spring contribution.

An inward opening injector can have a perforated plate-like arrangement in the nozzle outlet with an arrangement of holes chosen to create a suitable aerosol or the holes may be formed directly in the valve seat 39. As the needle is raised, some pressure is dropped between the needle ball-end and valve seating area. This is not considered to be useful pressure drop. Ideally, most of the pressure drop needs to occur across the holes in the plate or orifices 41 which create the aerosol.

### Fourteenth Fuel Injection Valve 1₁₄

The injectors hereinbefore described are inward-opening injectors. The use of a tubular body having an integrally-formed pole piece and other features, such as a stepped outer surface, can also be used in outward-opening injectors.

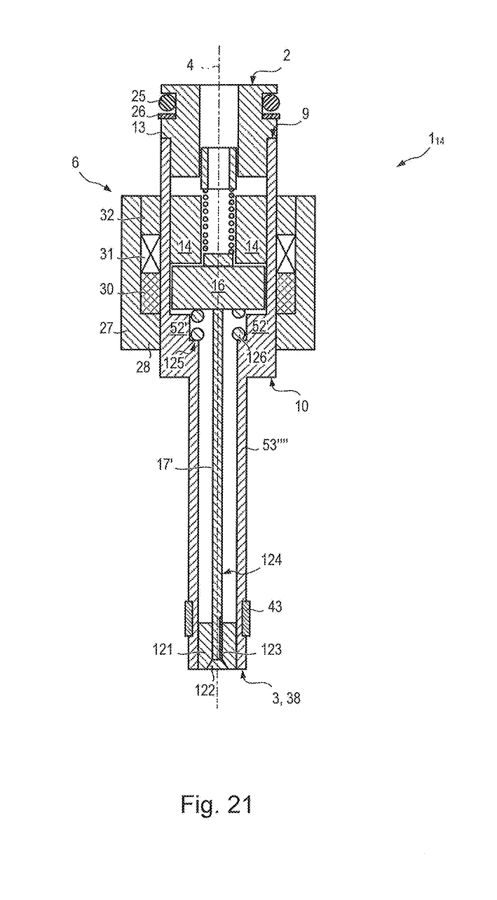

Referring to FIG. 21, a fourteenth solenoid-based fuel injector 1₁₄ is shown.

Referring also to FIG. 3, the fourteenth fuel injector 1₁₄ is similar to the third fuel injector 1₁₄ differing mainly in that it is an outward-opening injector having a different needle 17′, valve seat 121 and sealing element 122 in the form of a pintle head. The needle 17′ includes longitudinal recesses 123 on its outer surface 124 to allow fuel to flow when the valve is open.

The unitary tubular body and nozzle 53″″ also differs in that it has a modified pole piece 52′ which sacrifices an inner rim portion to provide a shelf 125 which allows a valve-closing spring 126 to be added between the shelf 123 and the armature 16. In this case, the stiff spring 126 takes the form of a helical spring. The spring 126 is sufficiently stiff to help the permanent magnet arrangement 30 to hold the valve closed for fuel pressures of 175 bar (17.5 MPa) or more. Furthermore, its stiffness may be chosen to enable stable partial lift.

### Fifteenth Fuel Injection Valve 1₁₅

The injectors hereinbefore described have a tubular body having an integrally-formed lower pole piece. The tubular body may, instead, have an integrally-formed upper pole piece.

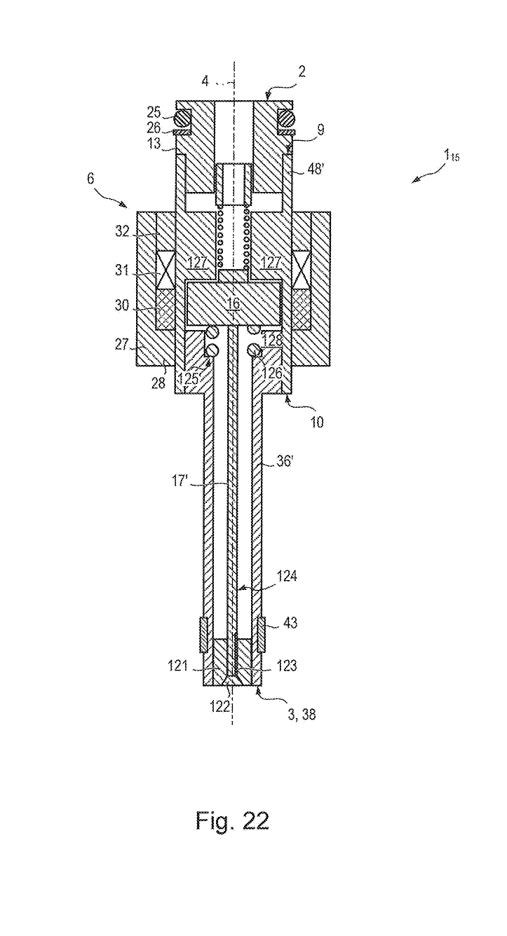

Referring to FIG. 22, a fifteenth solenoid-based fuel injector 1₁₅ is shown.

Referring also to FIG. 21, the fifteenth fuel injector 1₁₅ is similar to the fourteenth fuel injector 1₁₄ except that the fifteenth fuel injector 1₁₅ comprises a separate tubular body 48′ and nozzle 36′. The tubular body 48′ has an integrally-formed first pole piece 127. The nozzle 36′ also has an integrally-formed second pole piece 128 and has a shelf 125′ which allows a valve-closing spring 126 to be added between the shelf 123 and the armature 16.

### Modifications

It will be appreciated that many modifications may be made to the embodiments hereinbefore described. Such modifications may involve equivalent and other features which are already known in the design, manufacture and use of fuel injectors and component parts thereof and which may be used instead of or in addition to features already described herein. Features of one embodiment may be replaced or supplemented by features of another embodiment.

For example, injectors which do not have a stepped outer may be modified to have such as stepped outer surface. Conversely, injectors which have stepped outer surface may be modified not to have the stepped outer surface.

Moreover, injectors having a stepped outer surface, may be modified to include an annular recess adjacent to one or both pole gaps.

Injectors which do not have stiff springs may be modified to include a stiff spring, for example, to enable partial lift operation.

The injector's actuator need not be a flux-switched actuator and so the permanent magnet arrangement can be omitted. The space made available by the omission of the permanent magnets may be used for additional soft material, and possibly some additional coils. The additional soft material may form part of the tubular housing. In an inwardly-opening injector, the lower pole piece can be omitted so that, when the solenoid is actuated, the armature accelerates towards the upper pole piece.

Additionally, in a two-part pintle and armature arrangement, to compensate for a lack of magnetic closing force which would otherwise be generated by permanent magnet(s), an additional downward-acting spring (not shown) may be used to help the armature return to the closed position. An armature bottom stop (not shown) may be provided by a stop on the pintle or a stop projecting from a static part of the injector below the armature. In an outwardly-opening injector, the upper pole piece can be omitted so that, in response to energization of the coil, the armature moves downwards and opens the injector.

The injector actuator may include a spring which returns the armature to the lower pole piece (closed position). This may be beneficial in some instances with injectors with permanent magnets.

The properties of the mechanical spring may be chosen to mirror the hydraulic forces. The stiff spring may be disc, rod or thin-walled tube. The stiff spring may be shot-peened, laser-peened or vapour-blasted to improve fatigue life.

A part of the injector which is subjected to high pressures, such as the pressure tube or a pressure tube portion, may be autofrettaged (for example hydraulically or mechanically using an oversized die pulled or pushed into inner diameter) to improve its capability to withstand high fuel pressure and to help enable minimum wall thickness to be used. An outer surface of the pressure tube or a pressure tube portion may be shot-peened, laser-peened or vapour blasted to improve fatigue life and enable reduced thickness.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1. A solenoid-based fuel injector comprising:
a tubular body comprising a magnetic material;
an armature disposed inside the tubular body;
valve sealing element; and
a rod or needle arranged to couple the armature to the valve sealing element;
wherein the needle or rod is compliant.

2-34. (canceled)

35. The solenoid-based fuel injector of claim 1, wherein higher valve opening forces are available due to stretching of the rod or needle.

36. The solenoid-based fuel injector of claim 1, wherein the rod or needle has a diameter of about 0.5 mm.

37. The solenoid-based fuel injector of claim 1, wherein the rod or needle is a needle which is hollow with a thin wall thickness.

38. The solenoid-based fuel injector of claim 1, wherein the rod or needle is sufficiently thin so as to be stretchable during operation.

39. The solenoid-based fuel injector of claim 1, wherein the rod or needle comprises a high-tensile steel.

40. The solenoid-based fuel injector of claim 1, wherein the rod or needle has a length between 20 and 70 mm.

41. The solenoid-based fuel injector of claim 1, wherein the armature and the rod or needle are fixed together.

42. The solenoid-based fuel injector of claim 1, wherein the rod or needle is configured such that the armature accelerates before the valve opens.

43. The solenoid-based fuel injector of claim 1, wherein the rod or needle is configured such that the armature applies force within 100 μsec before the valve opens.

44. The solenoid-based fuel injector of claim 1, wherein the rod or needle is configured such that the armature applies force in less than a quarter, less than a half, less than a third of the spring mass system's natural period before the valve opens.

45. The solenoid-based fuel injector of claim 1, wherein damping is provided for the valve sealing element.

46. The solenoid-based fuel injector of claim 1, wherein damping is provided for the valve sealing element by a closely-fitting sleeve.

47. The solenoid-based fuel injector of claim 1, wherein the rod or needle and the valve sealing element are fixedly attached together.

48. A method of operating a solenoid-based fuel injector, the method comprising:
using a single-polarity driver which allow up to twice a static opening force to be achieved.

49. A method of operating a solenoid-based fuel injector, the method comprising:
using a dual-polarity driver which allows up to four times a static opening force to be achieved.

50. A method of operating a solenoid-based fuel injector, the method comprising:
using a dual-polarity driver which drives the needle in to compression in a first direction and then in a second, opposite direction.
